(19) United States
(12) Patent Application Publication
(10) Pub. No.: US 2007/0061466 A1
(43) Pub. Date: Mar. 15, 2007

(54) Parallel TCP without lock between sender and receiver

(75) Inventors: Giora Biran, Zichron Ya'akov (IL); Leah Shalev, Zichron Ya'akov (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/223,472

(22) Filed: Sep. 9, 2005

(51) Int. Cl. G06F 15/16

(52) U.S. Cl. 709/227; 709/225

(57) ABSTRACT

A method for implementing parallel TCP (transmission control protocol), the method including dividing a TCP connection state, which is accessible by a TCP sender and a TCP receiver, into a plurality of separate access areas, wherein none of the access areas can be updated by both the sender and the receiver, and accessing one or more of the access areas with the sender and/or receiver to write and/or read data. There is no need for locking between the sender and the receiver.

### FIELD OF THE INVENTION

The present invention relates generally to parallel implementation of TCP (transmission control protocol).

### BACKGROUND OF THE INVENTION

TCP is a protocol originally designed for use with a single serial implementation. Network transmission with TCP may be governed serially (in hardware and/or software). However, the enormous increase in network transmission rates has made straightforward serial implementation totally inadequate to meet performance requirements, whether in conventional processor-based implementations or in hardware implementations. Accordingly, parallel TCP implementation has been developed to solve this problem.

Different forms of parallelism are known. For certain implementations, an attractive approach is to split the original protocol state machine into multiple communicating state machines. One arrangement is that of a parallel split between a sender and a receiver, which is now briefly described with reference to FIG. 1.

In the prior art protocol for this parallel split, the sender and the receiver share a common connection state 10 associated with a context manager 12 which may manage the synchronization between the sender and receiver, and the use of locks discussed below.

The common connection state information may include, without limitation, window information used by the flow control and acknowledgement of information received by the receiver, for example. In the prior art, the common connection state information is a shared resource, accessible by both sender 14 and receiver 16. However, a problem with such a split is that data traveling in one direction may be mixed with control information for data traveling in the opposite direction. In particular, a single packet may carry data to be handled by the receiver 16 plus control to be handled partially by the receiver 16 and partially by the sender 14. In addition, sender-related control information affects receiver validation of the packet. For example, an invalid acknowledge number for the transmitted data may cause the receiver 16 to incorrectly discard the received data.

In order to solve this problem, a typical approach used in the prior art is that of locks. In this approach, when the sender 14 accesses the common connection state 10 (e.g., at time=x) for read or write operations, access is uniquely given to the sender 14 and the receiver 16 is temporarily denied access to the common connection state 10. After the sender 14 has completed its operation (e.g., at time=x+y), access is uniquely given to the receiver 16 for read or write operations, and the sender 14 is temporarily denied access to the common connection state 10. However, the introduction of locks involves many CPU cycles and memory accesses, which is a burden to the system and degrades system performance.

### SUMMARY OF THE INVENTION

The present invention seeks to provide improved parallel implementation of TCP without any need for locking between the sender and the receiver, as is described more in detail hereinbelow.

In one non-limiting embodiment, the TCP sender and the TCP receiver may carry out their processing in parallel, without locking of accesses to the shared state. The connection state may be divided into different access areas such that no variable can be updated by both the sender and the receiver. The sender and the receiver may independently read their respective access areas in parallel, by making atomic snapshots of the information in the particular access area. The sender and the receiver may write to the connection state, for example, by atomically writing state updates. The state updates may be implemented with a “relaxed consistency”, wherein instead of adhering to a strict global order of context updates, it is permissible to re-order the context updates in accordance with independent protocol events.

As mentioned hereinabove, packets may carry data to be handled by the receiver plus control to be handled partially by the receiver and partially by the sender. In the prior art, the sender and receiver processing are interleaved, wherein both require access to the same state of the connection state. A potential consistency problem exists for context fields updated by the receiver and read by the sender. Before the sender can process the protocol event, the sender is locked out and must wait for the receiver to first update the context field. The locking ensures that the sender has the correct “pre-event” information prior to processing the event. Only afterwards can the sender start processing the event. In other words, the context field is locked from the time it is read until the updated context is written back. The fetched context cannot be processed concurrently by the sender and the receiver.

In contrast, in a non-limiting embodiment of the present invention, each such context field is copied to two separate access areas of the connection state. One access area can be accessed only by the sender, whereas another one can be written to only by the receiver. In this way, the sender can obtain the correct “pre-event” connection state, independently of any update activity by the receiver. The parallel implementation of TCP can be carried out without any need for locking between the sender and the receiver. Additionally, the fetched context can be processed concurrently by both the sender and the receiver.

### BRIEF DESCRIPTION OF THE DRAWINGS

The present invention will be understood and appreciated more fully from the following detailed description taken in conjunction with the appended drawings in which:

FIG. 1 is a simplified block diagram illustration of a prior art TCP parallel implementation with locking between a sender and a receiver;

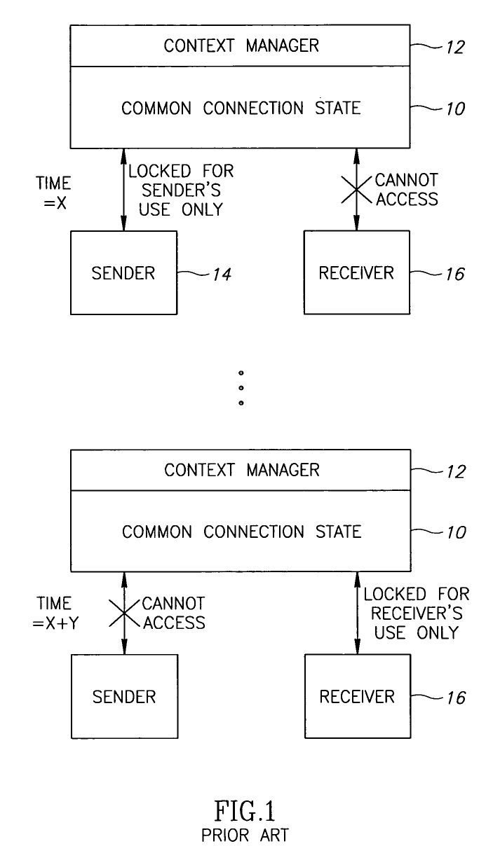

FIG. 2 is a simplified block diagram illustration of a TCP parallel implementation without locking between the sender and the receiver, in accordance with an embodiment of the invention;

FIG. 3 is a simplified flow chart illustration of a method for TCP parallel implementation using the apparatus of FIG. 2, in accordance with an embodiment of the invention; and

FIG. 4 is a simplified block diagram illustration of a portion of the control flow in the TCP parallel implementation of FIGS. 2 and 3, in accordance with an embodiment of the invention.

### DETAILED DESCRIPTION OF EMBODIMENTS

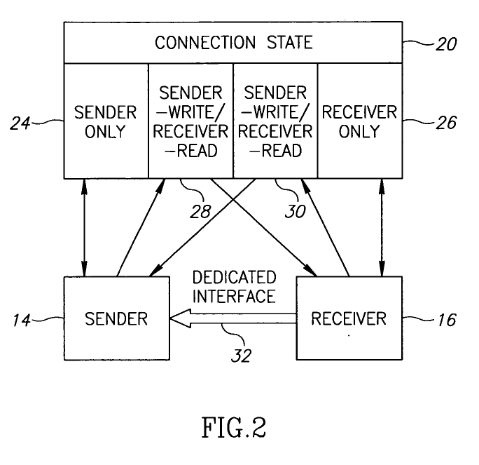

Reference is now made to FIG. 2, which illustrates a TCP parallel implementation in accordance with an embodiment of the present invention.

In accordance with an embodiment of the present invention, a TCP connection state 20 may be associated with a TCP context manager (not shown). A TCP sender 14 and a TCP receiver 16 (e.g., remote side of the TCP connection) may access the connection state 20. The connection state 20 may be organized and divided into a plurality of separate access areas. A first access area is a sender-only access area 24, meaning that only the sender 14 is permitted to write data thereto and read data therefrom. A second access area is a receiver-only access area 26, meaning that only the receiver 16 is permitted to write data thereto and read data therefrom. A third access area is a sender-write/receiver-read access area 28, meaning that the sender 14 is permitted to write and update data to area 28 but not read data therefrom, whereas the receiver 16 is permitted to read data from area 28 but not to write or update data thereto. A fourth access area is a receiver-write/sender-read access area 30, meaning that the receiver 16 is permitted to write and update data to area 30 but not read data therefrom, whereas the sender 14 is permitted to read data from area 30 but not to write or update data thereto. This partitioning of the connection state 20 means that no variable (access area) can be updated by both the sender 14 and the receiver 16.

A dedicated interface 32 may be used to transmit data from the receiver 16 to the sender 14. The dedicated interface 32 may be any suitable hardware or software interface. The dedicated interface 32 may be used to transmit data, such as but not limited to, sender-related control information and requests to transmit receiver-related control information (e.g., TCP control bits, acknowledgment field of a particular segment, sequence number of a particular segment, immediate and delayed acknowledgments, window updates and the like).

As mentioned hereinabove, packets may carry data to be handled by the receiver 16 plus control to be handled partially by the receiver 16 and partially by the sender 14. The context variables associated with the control to be handled by the sender 14 and the receiver 16 are referred to as the sender flow control variables or the sender flow control information (the terms being used interchangeably), which, amongst other things, may be used by the receiver 16 for packet validation. In accordance with an embodiment of the present invention, the sender flow control variables are duplicated, that is, the packet has two copies of them. One copy of the duplicated sender flow control variables may be written by the receiver 16 to the receiver-write/sender-read access area 30, and another copy may be written by the receiver 16 to the receiver-only access area 26. The copy written to the receiver-write/sender-read access area 30 may be accessed for reading by the sender 14 only, whereas the copy written to the receiver-only access area 26 may be accessed for reading by the receiver 16 only.

The sender 14 and the receiver 16 may access the connection state 20 atomically, wherein the state information is read/written in a single atomic operation. Unlike the prior art, the context associated with the connection state 20 is not locked starting from reading the context up to and including updating the context. Processing of the fetched context can be done concurrently by the sender 14 and the receiver 16.

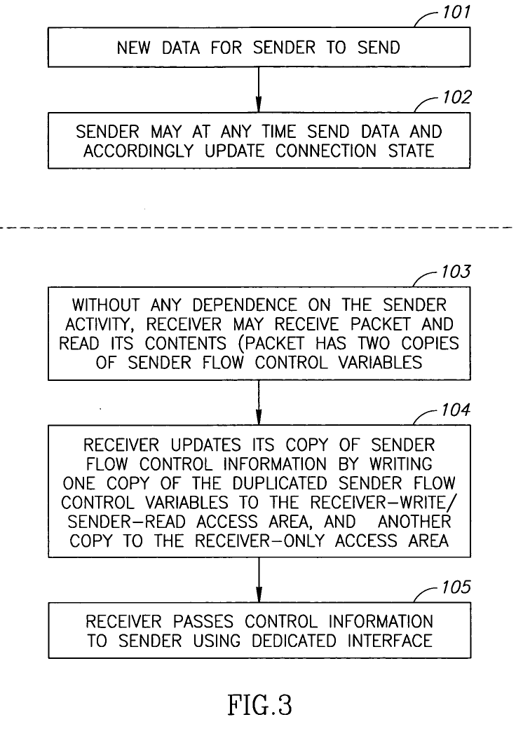

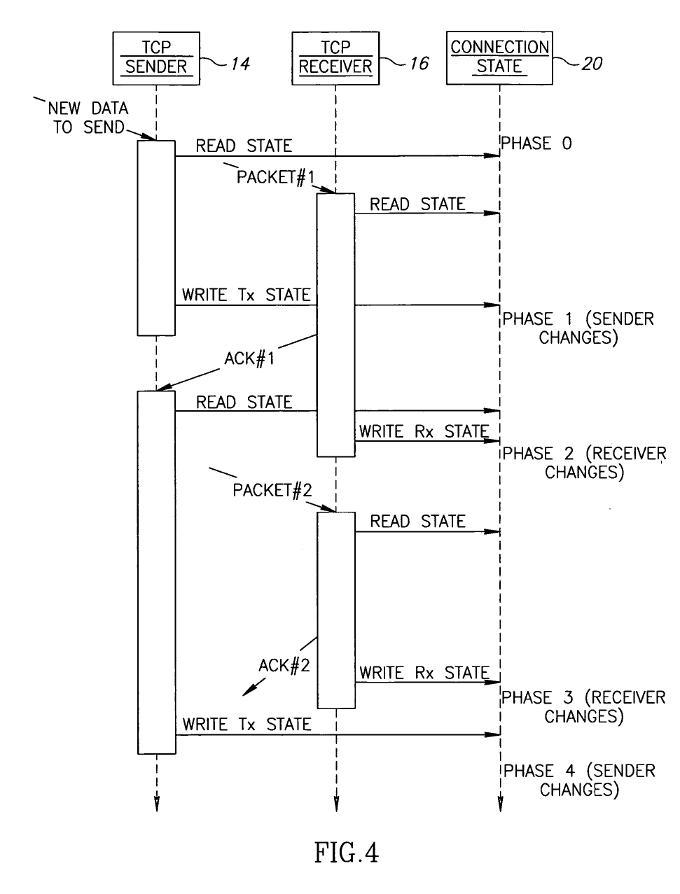

Reference is now made to FIGS. 3 and 4, which illustrate a method for TCP parallel implementation using the apparatus of FIG. 2, in accordance with an embodiment of the invention. The sender 14 may have new data to send (step 101). The sender 14 may initially be in a read state (phase 0 in FIG. 4), and may at any time send data and accordingly update the connection state 20 as seen in FIG. 4 (step 102, FIG. 3). Without any dependence on the sender activity, the receiver 16 may receive a packet (such as from some network, not shown) and read its contents (step 103). As mentioned before, the packet has two copies of the sender flow control variables. The receiver 16 may update its copy of sender flow control information, to be used for validation of the next packet, by writing one copy of the duplicated sender flow control variables to the receiver-write/sender-read access area 30, and writing another copy to the receiver-only access area 26 (step 104). The receiver 16 may pass control information to the sender 14, using the dedicated interface 32 (step 105). As mentioned before, the control information may include, without limitation, sender-related control information and requests to transmit receiver-related control information. In this manner, the sender 14 is guaranteed to read consistent, although not necessarily most up-to-date information. Without any dependence on the receiver 16, the sender 14 may process any necessary flow control updates, optionally after some delay, and update the sender-only access area 24 and the sender-write/receiver-read access area 28 with the sender's copy of the sender flow control variables.

As seen in FIG. 4, the sender 14 and the receiver 16 may update the connection state 20 with context updates with a “relaxed consistency”, wherein instead of adhering to a strict global order of context updates, it is permissible to re-order the context updates in accordance with independent protocol events. The relaxed consistency is possible due to the sender 14 and the receiver 16 being able to independently access the connection state 20 and due to the fact that no variable can be updated by both the sender 14 and the receiver 16.

The present invention may be used in an efficient parallel implementation of TCP in multiple communicating state machines. The invention may be implemented in hardware and software, such as but not limited to, multi-threading and embedded symmetric multiprocessing (SMP).

The methods shown in FIGS. 3 and 4 and described hereinabove, may be carried out by a computer program product, such as but not limited to, Network Interface Card (NIC), Host Bus Adapter (HBA), and the like, which may include instructions for carrying out the methods described hereinabove.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for implementing parallel TCP (transmission control protocol), the method comprising:
dividing a TCP connection state, which is accessible by a TCP sender and a TCP receiver, into a plurality of separate access areas, wherein none of the access areas can be updated by both the sender and the receiver; and
accessing at least one of the access areas with at least one of the sender and the receiver to perform at least one of writing data and reading data.

2. The method according to claim 1, wherein the plurality of separate access areas comprises:
a sender-only access area, wherein only the sender is permitted to write data thereto and read data therefrom,
a receiver-only access area, wherein only the receiver is permitted to write data thereto and read data therefrom,
a sender-write/receiver-read access area, wherein the sender is permitted to write thereto but not read data therefrom, whereas the receiver is permitted to read data therefrom but not write data thereto, and
a receiver-write/sender-read access area, wherein the receiver is permitted to write thereto but not read data therefrom, whereas the sender is permitted to read data therefrom but not write data thereto.

3. The method according to claim 1, further comprising transmitting data from the receiver to the sender via a dedicated interface.

4. The method according to claim 3, wherein transmitting data from the receiver to the sender via said dedicated interface comprises transmitting sender-related control information and requests to transmit receiver-related control information.

5. The method according to claim 1, wherein data received by the receiver comprises a packet that includes two copies of sender flow control variables.

6. The method according to claim 2, wherein data received by the receiver comprises a packet that includes two copies of sender flow control variables, and wherein one copy of the sender flow control variables is written by the receiver to the receiver-write/sender-read access area, and another copy is written by the receiver to the receiver-only access area.

7. The method according to claim 1, wherein said write and read operations comprise atomic write and read operations.

8. The method according to claim 1, further comprising not locking context associated with the connection state starting from reading the context up to and including updating the context.

9. The method according to claim 1, further comprising processing context fetched from said connection state concurrently by the sender and the receiver.

10. The method according to claim 1, further comprising the sender and the receiver updating the connection state with context updates without adhering to a strict global order of the context updates.

11. A computer program product for implementing parallel TCP, the computer program product comprising:
first instructions for dividing a TCP connection state, which is accessible by a TCP sender and a TCP receiver, into a plurality of separate access areas, wherein none of the access areas can be updated by both the sender and the receiver; and
second instructions for accessing at least one of the access areas with at least one of the sender and the receiver to perform at least one of writing data and reading data.

12. The computer program product according to claim 11, wherein the plurality of separate access areas comprises:
a sender-only access area, wherein only the sender is permitted to write data thereto and read data therefrom,
a receiver-only access area, wherein only the receiver is permitted to write data thereto and read data therefrom,
a sender-write/receiver-read access area, wherein the sender is permitted to write thereto but not read data therefrom, whereas the receiver is permitted to read data therefrom but not write data thereto, and
a receiver-write/sender-read access area, wherein the receiver is permitted to write thereto but not read data therefrom, whereas the sender is permitted to read data therefrom but not write data thereto.

13. The computer program product according to claim 11, further comprising third instructions for transmitting data from the receiver to the sender via a dedicated interface.

14. The computer program product according to claim 11, wherein data for the receiver comprises a packet that includes two copies of sender flow control variables, and wherein said second instructions comprise instructions for writing one copy of the sender flow control variables to the receiver-write/sender-read access area, and writing another copy to the receiver-only access area.

15. A system for implementing parallel TCP (transmission control protocol), the system comprising:
a TCP sender and a TCP receiver; and
a TCP connection state, which is accessible by the sender and the receiver, divided into a plurality of separate access areas, wherein none of the access areas can be updated by both the sender and the receiver.

16. The system according to claim 15, wherein the plurality of separate access areas comprises:
a sender-only access area, wherein only the sender is permitted to write data thereto and read data therefrom,
a receiver-only access area, wherein only the receiver is permitted to write data thereto and read data therefrom,
a sender-write/receiver-read access area, wherein the sender is permitted to write thereto but not read data therefrom, whereas the receiver is permitted to read data therefrom but not write data thereto, and
a receiver-write/sender-read access area, wherein the receiver is permitted to write thereto but not read data therefrom, whereas the sender is permitted to read data therefrom but not write data thereto.

17. The system according to claim 15, further comprising a dedicated interface for transmitting data from the receiver to the sender.

18. The system according to claim 15, wherein said data comprises a packet that includes two copies of sender flow control variables.

19. The system according to claim 16, wherein data for the receiver comprises a packet that includes two copies of sender flow control variables, and wherein one copy of the sender flow control variables is written by the receiver to the receiver-write/sender-read access area, and another copy is written by the receiver to the receiver-only access area.
